(19) United States
(12) Patent Application Publication
(10) Pub. No.: US 2025/0190848 A1
(43) Pub. Date: Jun. 12, 2025

(54) SIGNAL AWARE MODEL LEARNING

(71) Applicant: INTERNATIONAL BUSINESS MACHINES CORPORATION, Armonk, NY (US)

(72) Inventors: Sahil Suneja, Ossining, NY (US); Jim Alain Laredo, Katonah, NY (US)

(21) Appl. No.: 18/533,259

(22) Filed: Dec. 8, 2023

(51) Int. Cl. G06N 20/00; G06N 7/01

(52) U.S. Cl. CPC G06N 20/00; G06N 7/01

(57) ABSTRACT

A method, computer system, and a computer program product are provided. A machine learning model is trained by inputting a code sequence. During the training, a minimal sub-sequence is extracted from the input code sequence. The minimal sub-sequence preserves a prediction that the machine learning model made for the input code sequence. The minimal sub-sequence constitutes a valid program A true class label for the minimal sub-sequence is obtained. The machine learning model is optimized with the true class label and by using the extracted minimal sub-sequence as a proxy for the input code sequence.

### BACKGROUND

The present invention relates generally to the fields of machine learning models, machine learning models configured to perform programming code-related tasks, and training machine learning models to better recognize task-relevant features in code samples that are input.

### SUMMARY

According to one exemplary embodiment, a computer-implemented method is provided. A machine learning model is trained by inputting a code sequence. During the training, a minimal sub-sequence is extracted from the input code sequence. The minimal sub-sequence preserves a prediction that the machine learning model made for the input code sequence. The minimal sub-sequence constitutes a valid program. A true class label for the minimal sub-sequence is obtained. The machine learning model is optimized with the true class label and by using the extracted minimal sub-sequence as a proxy for the input code sequence. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a pipeline illustrating aspects of training a machine learning model to become more signal aware according to at least one embodiment;

FIG. 2 illustrates an example of producing a minimal sub-sequence for proxy use that is used in the process of FIG. 2 according to at least one embodiment;

FIG. 3A illustrates a first portion of another example of producing a minimal sub-sequence for proxy use that is used in the process of FIG. 1 according to at least one embodiment;

FIG. 3B illustrates a second portion of the example whose first portion was shown in FIG. 3A;

FIG. 4 illustrates an iterative reduction pipeline that according to at least one embodiment is used as part of the pipeline for machine learning training shown in FIG. 1;

FIG. 5 illustrates aspects of finding an additional local minimum according to at least one embodiment using the above-described training for the machine learning model to be more signal aware; and

FIG. 6 illustrates a networked computer environment in which machine learning model training is performed according to at least one embodiment to help the machine learning model become more signal aware.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a computer system, a method, and a computer program product for improving training of a machine learning model that performs programming code-related tasks so that the machine learning model better learns to recognize task-relevant features within the submitted code that is analyzed. AI machine learning models that perform programming code-related tasks have made significant progress over the last few years but still sometimes are confused by noise within the code. Sometimes models consider tangential or unrelated features as evidence of a condition, when in reality these features are sometimes correlated to the condition but are just noise. The present embodiments apply machine learning training techniques to help the ML model improve its signal awareness and better recognize which code features are necessarily part of a recognized condition. In this embodiment a signal of the code is sometimes herein referred to as a feature of the code. Machine learning models which analyze code are trained to recognize and identify certain features or signals that are present within the code. Machine learning models improved in this way have increased robustness and generalizability and more widespread ability for practical usage. The present embodiments also implement, via usage of the minimized input, improved training of the machine learning model. Tests using a software vulnerability detection use-case uncovered a significant lack of signal awareness in machine learning models across different neural network architectures and across different datasets. The models were presumably picking up a lot of noise or dataset nuances while learning their logic. By implementing techniques described herein, the models were pushed towards more task-relevant learning and achieved substantial improvements in model signal awareness. The present embodiments implement a white-box approach to help overcome reliability concerns in current machine learning models, even for some current machine learning models with high accuracy/F1 scores. The present embodiments implement a symbiosis of software engineering and artificial intelligence, with software engineering assisting artificial intelligence which in turn assists additional software engineering. The present embodiments are agnostic with respect to one or more of the machine learning model, machine learning model task, and programming language of code analyzed.

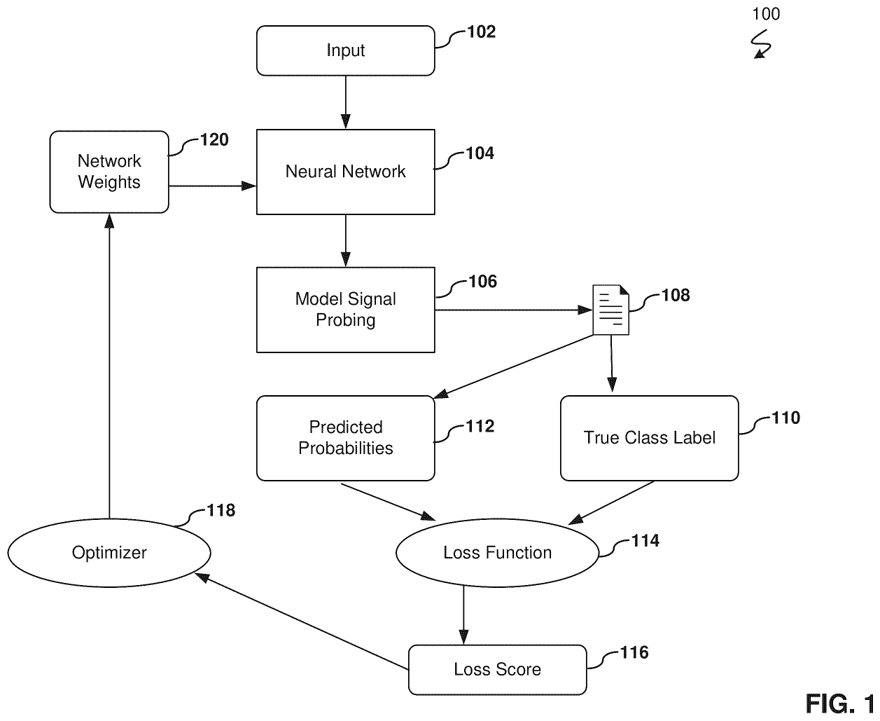

FIG. 1 illustrates a signal awareness enhancement pipeline 100 illustrating involved components for training of a machine learning model to be signal aware.

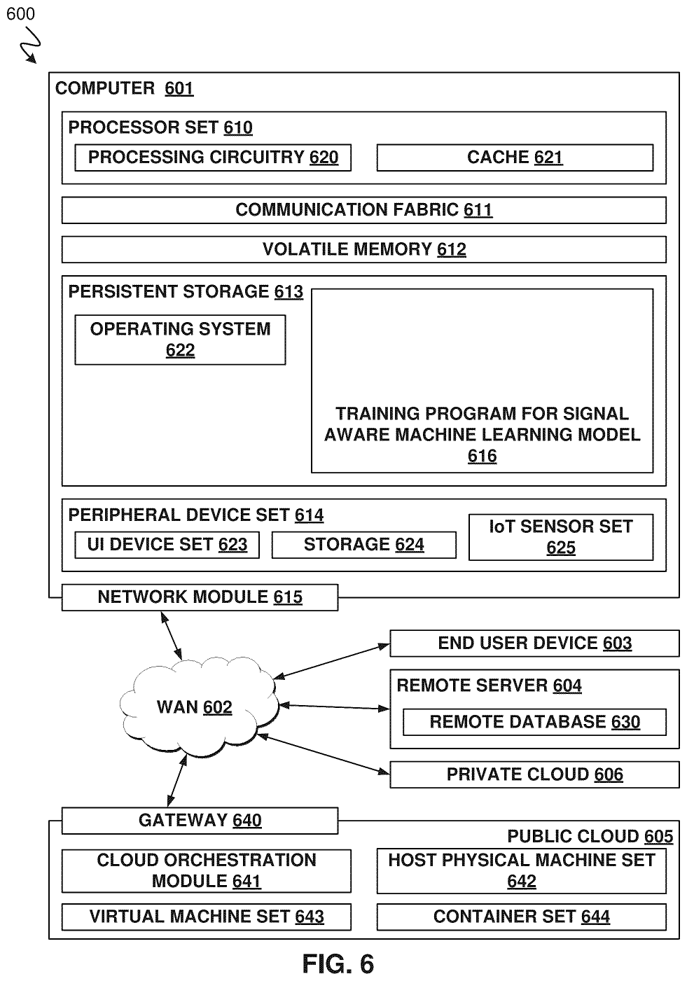

In a first portion of the signal awareness enhancement pipeline 100 shown in FIG. 1, a data sample is input 102 into the machine learning model that in some embodiments includes a neural network 104. The data sample includes programming code, e.g., programming code in a first programming language. The neural network 104 in some embodiments is stored on a local computer such as the computer 601 shown in FIG. 6. A copy of the neural network is downloaded to the local computer such as the computer 601 and/or is generated/built at the local computer. In other embodiments, the neural network 104 is hosted at a remote computer such as the remote server 604 shown in FIG. 6 and a local computer submits input samples to the remotely-located neural network 104 via a data transmission, e.g., through a wide area network 602 shown in FIG. 6. The neural network transmits its output back across the wide area network 602 to the computer 601 via a return data transmission.

FIG. 1 shows the machine learning model as including a neural network 104, but in other embodiments other types of artificial intelligence (AI) models are implemented in place of the neural network 104. Other artificial intelligence models to be implemented in other embodiments include, but are not limited to: perceptron (“P”), feed forward (“FF”), radial basis network (“RBF”), deep feed forward (“DFF”), recurrent neural network (“RNN”), long/short term memory (“LSTM”), gated recurrent unit (“GRU”), auto encoder (“AE”), variational AE (“VAE”), denoising AE (“DAE”), sparse AE (“SAE”), Markov chain (“MC”), Hopfield network (“HN”), Boltzmann machine (“B”), deep belief network (“DBN”), deep convolutional network (“DCN”), deconvolutional network (“DN”), deep convolutional inverse graphics network (“DCIGN”), generative adversarial network (“GAN”), liquid state machine (“LSM”), extreme learning machine (“ELM”), echo state network (“ESN”), deep residual network (“DRN”), Kohonen network (“KN”), support vector machine (“SVM”), and/or neural Turing machine (“NTM”).

Machine learning (ML), which is a subset of AI, utilizes algorithms to learn from data and create foresights based on the data. ML is the application of AI through creation of models, for example, artificial neural networks that can demonstrate learning behavior by performing tasks that are not explicitly programmed. There are different types of ML including learning problems, such as supervised, unsupervised, and reinforcement learning, hybrid learning problems, such as semi-supervised, self-supervised, and multi-instance learning, statistical inference, such as inductive, deductive, and transductive learning, and learning techniques, such as multi-task, active, online, transfer, and ensemble learning. The present embodiments are especially applicable to machine learning models that utilize loss minimization such as linear regression models, logistic regression models, support vector machines, neural networks (e.g., with deep learning), decision trees and random forests, gradient boosting machines, K-means clustering models, generative adversarial networks, etc.

In response to receiving the input 102, the neural network 104 provides a prediction about the input 102. The prediction relates to the task for which the neural network 104 is intended to perform or is being trained. This prediction is or is part of the output of the neural network 104. In at least some embodiments, the prediction relates to one or more source code understanding tasks that the neural network or other model is attempting to perform. The source code understanding tasks include, but are not limited to, function naming, variable naming, code summarization, code recommendation, code completion, defect detection, vulnerability detection, and bug fixing.

Embodiments of the invention can be implemented using machine learning models that include neural networks, which are a specific category of machines that can mimic human cognitive skills. In general, a neural network is a network of artificial neurons or nodes inspired by the biological neural networks of the human brain. Each or some of the nodes can have a mathematical function, such as for a node with two inputs, where the function is output=input value1*a connection strength value1+input value2*a connection strength value2. The node receives electrical signals from inputs, multiplies each input by the strength of its respective connection pathway, takes a sum of the inputs, passes the sum through a function, f(x), and generates a result, which may be a final output or an input to another node, or both. The * symbol above represents a multiplication. Weak input signals are multiplied by a small connection strength number, so the impact of a weak input signal on the function is low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

In a simplified example of a deep learning neural network architecture (or model), the neural network implements a set of algorithms running on a programmable computer (e.g., computing environment 600 shown in FIG. 6). In some instances, neural networks are implemented on an electronic neuromorphic machine that attempts to create connections between processing elements that are substantially the functional equivalent of the synapse connections between brain neurons. In either implementation, neural networks are able to incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a neural network is to recognize patterns by interpreting sensory data through a kind of machine perception. Real-world data in its native form (e.g., programming code) is converted to a numerical form (e.g., a vector having magnitude and direction) that can be understood and manipulated by a computer. The neural network is “trained” by performing multiple iterations of learning-based analysis on the real-world data vectors until patterns (or relationships) contained in the real-world data vectors are uncovered and learned.

Neural networks use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a neural network can be used to perform a variety of tasks, two of the more common tasks are labeling (or classification) of real-world data and determining the similarity between segments of real-world data. Classification tasks often depend on the use of labeled datasets to train the neural network to recognize the correlation between labels and data. This is known as supervised learning. For code-related tasks, e.g., source code understanding tasks, the neural network 104 is trained or pre-trained to perform function naming, variable naming, code summarization, code recommendation, code completion, defect detection, bug fixing, vulnerability detection, and/or other tasks. Similarity tasks apply similarity techniques and (optionally) confidence levels to determine a numerical representation of the similarity between a pair of items/code.

In some embodiments the neural network architecture/model is organized as a weighted directed graph. The artificial neurons are nodes and weighted directed edges (i.e., directional arrows) connect the nodes. The neural network architecture/model is organized such that some nodes are input layer nodes, other nodes are first hidden layer nodes, other nodes are second hidden layer nodes, and other nodes are output layer nodes. A neural network having multiple hidden layers indicates that the neural network model is a deep learning neural network architecture/model. Each node is connected to every node in the adjacent layer by connection pathways, which in some embodiments each includes its own connection strength. Although the example with one input layer, two hidden layers, and one output layer was described above, in practice multiple input layers, multiple hidden layers, and/or multiple output layers are provided in various embodiments.

Similar to the functionality of a human brain, each input layer node of the neural network receives inputs directly from a source with no connection strength adjustments and no node summations. Each of the input layer nodes applies its own internal function to the received input values and thereby produces an output value. In some embodiments, each of the first hidden layer nodes receives its inputs from all input layer nodes according to the connection strengths associated with the relevant connection pathways. Thus, in a first hidden layer node, its function is a weighted sum of the functions applied at the various input layer nodes in which the weight is the connection strength of the associated pathway into the first hidden layer node. A similar connection strength multiplication and node summation is performed for the remaining first hidden layer nodes, the second hidden layer nodes, and the output layer nodes.

A neural network 104 is in various embodiments implemented as a feedforward neural network or a recurrent neural network. A feedforward neural network is characterized by the direction of the flow of information between its layers. In a feedforward neural network, information flow is unidirectional, which means the information in the model flows in only one direction—forward—from the input nodes, through the hidden nodes (if any) and to the output nodes, without any cycles or loops. Recurrent neural networks, however, have a bi-directional information flow. Feedforward neural networks are trained using a backpropagation method.

Neural networks typically utilize and leverage embedding spaces. An embedding is a relatively low-dimensional space into which high-dimensional vectors can be translated. Embeddings make it easier to apply machine learning to large inputs like sparse vectors representing words or code. In general, neural network models take vectors (i.e., an array of numbers) as inputs. Vectorization includes taking the programming code characters that are received, extracting information from the group of characters, and associating the various words or commands to a vector using a suitable vectorization algorithm that takes into account the context in the code of a particular word/command. Embeddings are a way to use an efficient, dense vector-based representation in which similar words/commands have a similar encoding. In general, an embedding is a dense vector of floating-point values. Each embedding is a dense vector where a vector represents the projection of the word or command into a continuous vector space. The length of the vector is a parameter that must be specified. The values of the embeddings are trainable parameters (i.e., weights learned by the model during training in the same way a model learns weights for a dense layer). The position of a word or command within the vector space of an embedding is learned from code in the relevant programming language domain and is based on the other words or commands or values that surround the word/command when it is used. The position of a code element in the learned vector space of the embedding is referred to as its embedding. For example, in one embodiment each code element is represented as a 4-dimensional vector of floating-point values. An embedding can be thought of as a “lookup table.” After the weights have been learned, each code element is encoded by looking up the dense vector it corresponds to in the table. The embedding layer (or lookup table) maps from integer indices (which stand for specific programming elements) to dense vectors (their embeddings). The dimensionality (or width) of the embedding is a parameter that can be selected to match the task for which it is designed. When an embedding layer is created, the weights for the embeddings are randomly initialized (just like any other layer). During training, the weights are gradually adjusted via back-propagation training techniques. Once trained, the learned code embeddings will roughly encode similarities between code elements (as they were learned for the specific problem on which the model is trained).

An algorithm representing at least some of the present embodiments includes:

```
Input: Model M, Training set S, Oracle O
Output: Signal-aware model M
Steps:
For each training epoch
  For each training set sample s from S
    s’ = Minimal snippet extracted from s using Model Probing on M
    y = True class label for s’ obtained using oracle O
    y’ = Class probability of s’ by querying model M on s’
    1 = Loss(y, y’)
  Update model weights to minimize loss 1 across all samples
```

For an initial pass through the neural network 104 for the signal awareness model pipeline 100, the neural network 104 is already pretrained on a task or has not received training. In either approach, the inputting of the input 102 into the neural network 104 helps train the neural network 104 further as will be explained subsequently for the additional elements of the pipeline 100. For a neural network that does not have pre-training, the neural network still is built with programming code to produce a desired task output.

Examples of the machine learning model and neural network 104 described herein as being involved in and better trained with at least some of the present embodiments include a convolutional neural network which treats the programming code as a photo, a recurrent neural network which treats the programming code as a linear sequence of tokens, and a graph neural network which operates on the programming code as a graph.

For some embodiments that have a convolutional neural network, the code is treated as a photo and tries to learn the pictorial relationship between source code tokens and underlying code features. Token normalization can be performed before feeding data into the model. Token normalization involves normalizing the function names and variable names to fixed tokens such as “Func” and “Var”. In one embodiment, the embedding layer dimension is set as thirteen, followed by a 2d-convolutional layer with input channel as 1, output channel as 512, and kernel size as (9, 13). In some embodiments, the final prediction is generated by a 3-layer multilayer perceptron (MLP) with output dimensions being 64, 16, and 2.

For some embodiments with a recurrent neural network, the code is treated as a linear sequence of tokens and the model attempts to recognize features in the code using the temporal relationship between its tokens. An input function can be normalized during preprocessing, the same as for the convolutional neural network model embodiment described above. An embedding layer dimension is set as 500 in an embodiment, followed by a two-layer bi-directional gated recurrent unit module with hidden size equal to 256. The final prediction is generated by a single-layer multilayer perceptron.

For embodiments with a graph neural network, the model operates at a more natural graph-level representation of source code. The model tries to learn feature signatures, e.g., vulnerability signatures, in terms of relationships between nodes and edges of a code property graph. In some of the graph neural network embodiments, token normalization is not performed, e.g., is not performed during preprocessing. An embedding size can be set as sixty-four for some embodiments, followed by a gated graph sequence neural network layer with hidden size 256 and five unrolling time steps. The node representations are obtained via summation of embeddings of all node tokens. The graph representation read-out is constructed as a global attention layer. The final prediction can be generated by a 2-layer multilayer perceptron with output dimensions 256 and 2.

In response to a first input code sample of the input 102 being input into the neural network 104, the program, e.g., the model signal awareness enhancement program 616, probes the neural network 104 and extracts the input sample as well as the prediction made by the neural network 104 regarding the input sample. For example, for a neural network that is built to detect a defect in code and in response to the neural network predicting that the first input sample includes a bug, this bug determination and the input sequence are retrieved by the program 616.

The program 616 applies a minimization process to the input code sequence in order to determine a minimal sub-sequence of this input code sequence which is still valid code and still contains the signal or feature, e.g., the bug, the vulnerability, lack of a bug, lack of a vulnerability, etc. that was identified by the neural network. This minimization process includes iteratively reducing portions of the input code sequence until the minimal sub-sequence is obtained. The minimal sub-sequence is a smallest portion of the first sub-sequence that causes the model to generate the same prediction that it did for the original input code sequence and that still constitutes a valid program. In some instances, the program 616 retrieves tokens representing the input and performs the iterative reduction by removing tokens from the token set and then by analyzing the remaining tokens in the set after the removal.

The program 616 performs the minimization by applying a program reduction engine such as a delta debugging algorithm. The program 616 includes and/or accesses this program reduction engine to perform the reduction. The delta debugging algorithm reduces the input sample until not a single element can be removed without altering the prediction of the machine learning model. This algorithm checks alternative narrower sections and, if none preserves the prediction or none contains a valid code then the last step back is the minimal sequence. This minimal sequence determined through the delta debugging algorithm is referred to as a 1-minimal subset. Delta debugging uses an iterative split-and-test algorithm to reduce an input sequence. In some instances the reduction engine algorithm works like a binary search to systematically and efficiently identify the minimal sub-sequence.

The delta debugging algorithm reduces the input code sample at the level of source code tokens and iteratively splits the sample until a valid 1-minimal sub-program is identified. The iterative reduction in some embodiments is driven by an oracle which decides whether or not the resultant reduction should be picked for subsequent potential reductions. The oracle requires the reduced subprogram(s) to (1) preserve the prediction made by the machine learning model, (2) contain a valid program that is compilable, and (3) optionally preserve the specific type and location of feature for the prediction that was made by the machine learning model for requirement (1). The minimal sub-sequence that is produced represents the bare minimum excerpt of the input sample which the neural network 104 needs to arrive at and stick with its original prediction. The Algorithm 1 provided below is an example of functions of a delta debugging oracle that preserves a prediction of the model in a vulnerability detection setting/use case.

Algorithm 1

Input:

S: C/C++ program token sequence
M: A vulnerability detection model
V: Original program's vulnerability information (bug and location)

Output:
True: S represents a valid but vulnerable program per M. It should be further checked for
reduction opportunities.
False: Otherwise.

| | |
|---|---|
| 1: | function T(S) |
| 2: | p ← Token2Program(S) |
| 3: | if ValidProgram(p) and M(p) = Vulnerable then |
| 4: | if Same Vuln(p, v) or NoVuln(p) then |
| 5: | return True |
| 6: | else |
| 7: | return False |
| 8: | else |
| 9: | return False |

Lines 3 and 4 require the reduced subprogram to satisfy the prediction preserving (location and
type) and valid program requirements.

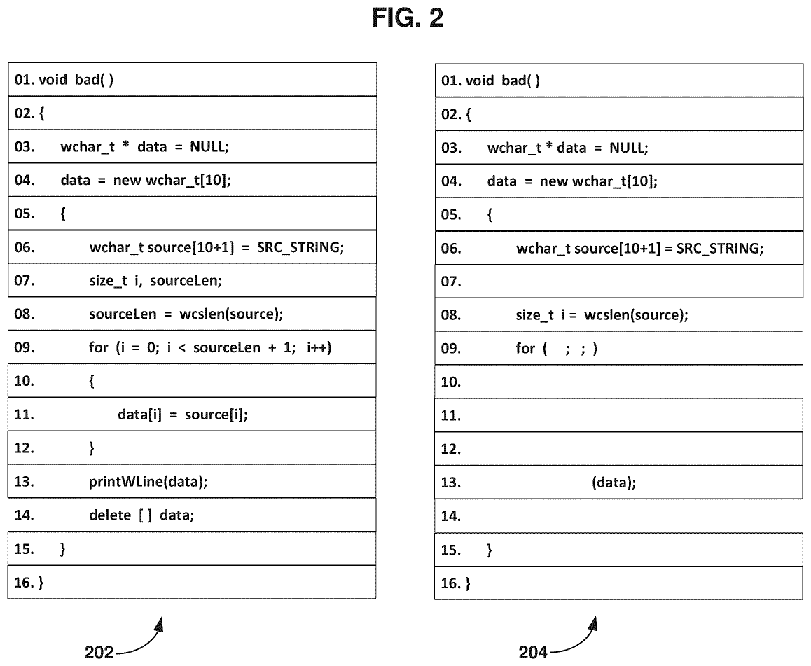

FIG. 2 illustrates an example of how, without the program 616 and the techniques applied herein, a machine learning model can receive incorrect learning during its training. The left column shows a first input sequence 202 of programming code. The right column shows a first reduced sequence 204 of the programming code that started from the first input sequence 202. The first input sequence 202 was input into a neural network and the neural network provided a responsive output that the line 11 is buggy code. An oracle confirmed this determination for line 11. A reduction was performed to the first input sequence 202 to produce the first reduced sequence 204. However, the neural network predicts that the first minimal subsequence 204 is buggy, but the oracle indicates that the first minimal subsequence is non-buggy. Although line 11 contained the buggy code, the machine learning model believed that one or more other lines of code from the first input sequence 202 were causing the bug. In reality, however, the other lines were not causing the bug.

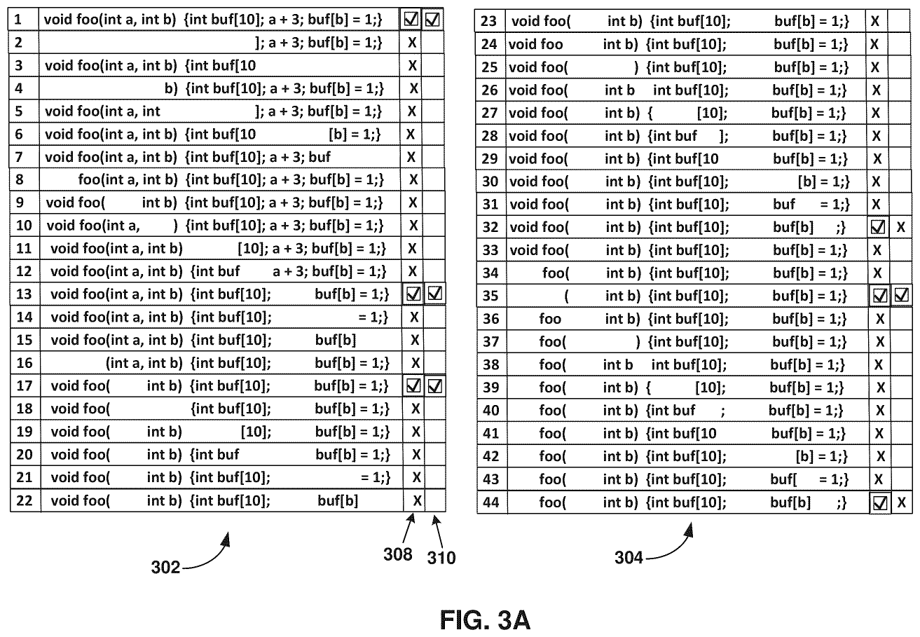

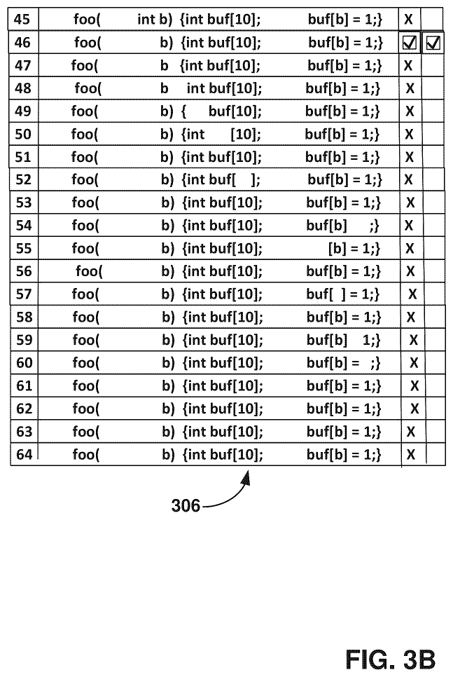

FIGS. 3A-3B illustrate an example of the program 616 receiving input code (e.g., via probing and extracting a code sample that was input to a machine learning model) and extracting a minimal sub-sequence from the input code sequence, whereby the minimal sub-sequence preserves the model initial prediction made on the original input code sequence and the minimal sub-sequence constitutes a valid program. The various code reductions that are applied by the program 616 are shown starting from the top left corner in line 1 of the left column 302 of FIG. 3A, proceed from top to bottom sequentially per line of code from line 1 through line 22 in the left column 302, then to the right column 304 in FIG. 3A and going from lines 23 to 44. Then the process continues in FIG. 3B with the third column 306 having lines 45 to 64 shown. For each line of the code, a first check is made as indicated in the valid code check column 308. An “X” in an individual line portion of the valid code check column 308 indicates that the code of the particular line was submitted to a compiler (and/or code validator and/or code verifier) which determined that the line of code was invalid. A “/” in an individual line portion of the valid code check column 308 indicates that the code of the particular line was submitted to a compiler which determined that the line of code was valid. If the line of code is found to be invalid, a check for prediction preservation is not necessary. If the line of code is found to be valid, a prediction preservation check is performed whose results are indicated in the prediction preservation check column 310. An “X” in an individual line portion of the prediction preservation check column 310 indicates that the code of the particular line was submitted to the model as a requery and the resultant output from the model did not preserve the initial prediction that the model made for the original code sequence. A “/” in an individual line portion of the prediction preservation check column 310 indicates that the code of the particular line was submitted to the model as a requery and the resultant output from the model preserved the initial prediction that the model made for the original code sequence.

In the original program sequence that is input for the example of FIGS. 3A-3B, a buffer overflow can be triggered with the code “buf[b]=1” when b>=10. The steps show how the program 616 gradually adjusts the granularity of editing and reduces the tokens. In iterations #2-#3 (iterations referring to the code line in FIGS. 3A-3B), the token sequence is split into two parts but neither is a valid program. Hence, in iterations #4-#7 the delta debugging algorithm of the program 616 operates on a finer granularity and the sequence is split into four parts. Because the program 616 cannot find any valid subprograms in iterations #4-#7, the program 616 doubles the sequence split into eight parts and finds a valid subprogram in iteration #13. Because the program 616 verifies that the code on line #13 is valid and because the model predicts the code on line #13 to be vulnerable (thereby preserving the initial prediction on the input sequence in line #1), the statement “a+3” is removed for additional investigation. After that, the program 616 finds iterations #17, #34 and #46 with particular portions removed (“int a”, “void”, and the “int” before the “b”, respectively) are valid subprograms which preserve the model prediction of vulnerability. Thus, after these iterations the program 616 seeks to find a line of code with more tokens removed, but the additional reductions (shown through line 64) did not produce any smaller valid subprograms. Thus, iteration #46 (“foo(b) {int buf[10]; buf[b]=1;}”) is the prediction preserving minimal sub-sequence (1-minimal). Iteration #46 preserves the vulnerability prediction so the program 616 counts the code/token sequence of iteration #46 as correctly presenting the signal predicted by the model. Removing any additional token from the minimal sub-sequence identified above will cause the code to no longer be valid code and/or will cause the model prediction to flip (e.g., from vulnerable to non-vulnerable). Iterations #32 and #44 found reductions that could still provide valid code; however, these reductions caused the remaining code to flip the model prediction, in this case to a prediction of not vulnerable. Thus, iterations #32 and #44 were discarded as being unsuitable for the one-minimal subsequence or for further investigations based on the respective code reduction.

In other embodiments, an alternative program reduction engine is used that includes a hierarchical delta debugging algorithm that works on tree-structured inputs that consist of context-free grammar and that prunes unnecessary sub-trees during the reduction. In other embodiments, an alternative program reduction engine is used that includes a syntax-guided program reduction such as Perses that works using deletion elements and/or transformations on code portions to identify valid program reductions. In other embodiments, an alternative program reduction engine is used that performs parallel test-case reduction that kills outstanding interestingness searches when an interesting new variant is identified. The engine then launches a new speculation line. To investigate potential suitable reductions, the engine performs transformations of code portions that should be stateless and that include passes which should implement a linear sequence of transformations which results in variants that are deemed interesting or not interesting. Commands of new object returns, new transformation returns, and transformation are implemented.

In other embodiments, one or more simpler alternatives are employed for the minimization. The simpler alternatives include linear, brute-force or randomized schemes for selecting source code tokens/statements for reduction.

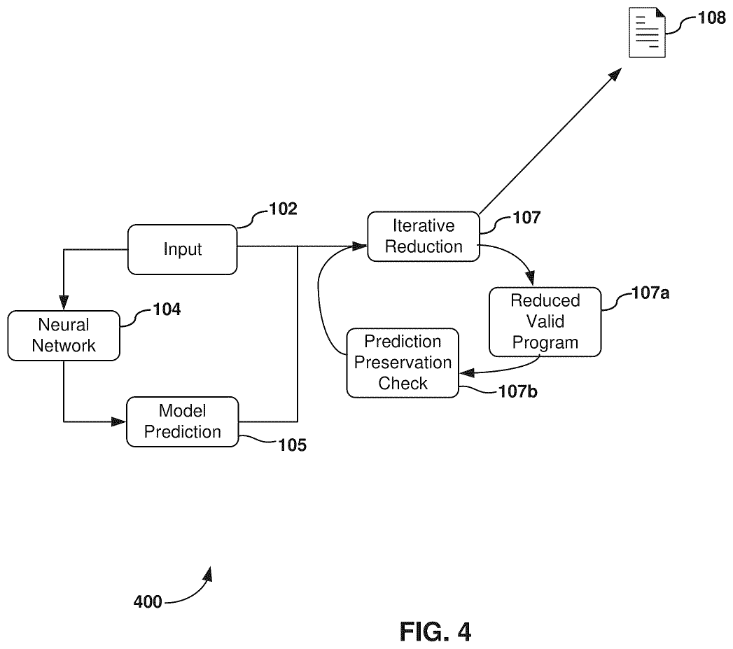

FIG. 4 illustrates an iterative reduction pipeline 400 that according to at least one embodiment is used as part of the signal awareness enhancement pipeline 100 shown in FIG. 1. The iterative reduction pipeline 400 is implemented to find the minimal subsequence. As shown in FIG. 4, the input 102 and the model prediction 105 that is output from the neural network 104 (or other machine learning model in other embodiments) are input for the iterative reduction module 107 of the program 616. The iterative reduction module 107 in some examples includes a delta debugging algorithm as described above. The iterative reduction module 107 applies techniques to find a reduced valid program 107a. For the reduced valid program investigation, changed code lines that received reductions are input to one or more of a compiler, a code validator, and a code verifier, and in response the compiler, code validator, and/or code verifier indicates whether the changed code line is still valid code. The compiler is a programming language-specific compiler (tailored to the language of the code being analyzed by the machine learning model and the pipeline 100) or is able to perform compiling for multiple languages. A valid code is a code that follows syntax and semantics of a programming language. In some embodiments, a valid code must be able to resolve to a value. For those changes that are valid code, the changed code line is then submitted for a prediction preservation check 107b.

In at least some embodiments, this prediction preservation check 107b includes resubmitting the reduced valid program back to the neural network 104 and, in response, receiving the output prediction that the neural network 104 resultantly makes. The second or current prediction is compared to the original prediction made for the original input 102. For a prediction match, the reduced code sequence is deemed to have preserved the prediction. For a prediction non-match, the reduced code sequence is deemed to have changed the prediction. Thus for the non-match this reduced code sequence is not a candidate for noise awareness training. In some embodiments, the prediction preservation check 107b also includes a check whether a feature location and feature type for the prediction remained consistent in the reduced code (iteratively for the respective reduced valid program up to the minimal subsequence). By rechecking here the neural network prediction for the reduced code portion, the program 616 learns what the model is thinking with respect to the reduced code portion. In this way, the training loss of the model is able to be updated during subsequent loss optimization. The program 616 needs to know what the model is thinking about the code segment in order to be able to adjust the model during backpropagation as part of loss optimization.

The iterative reduction 107 repeats through portions 107a, 107b multiple times until no further reductions are available which could maintain valid code and preserve the model prediction. After the iterative reduction 107 is finished, the final resultant code is the minimal subsequence 108.

Returning to the signal awareness enhancement pipeline 100 of FIG. 1, after the minimal subsequence 108 is obtained, the pipeline 100 proceeds by obtaining a true class label 110 regarding the minimal subsequence 108 and also by inputting the minimal subsequence 108 back into the neural network 104 to obtain predicted probabilities 112 that the neural network 104 predicts for the minimal subsequence 108. The true class label 110 is obtained from an oracle. In some iterations, the true class label 110 obtained from the oracle is different from the label of the original input sequence. In some iterations, the true class label 110 obtained from the oracle is the same as the label of the original input sequence. A loss function 114 is applied to compare the predicted probabilities 112 and the true class label 110 to obtain a loss score 116. The loss score 116 is then used by an optimizer 118 to adjust weights 120 of the neural network to continue training the neural network 104 to seek to minimize the loss function. By performing this neural network optimization, the neural network 104 is trained to better recognize features or signals as being associated with code that truly holds/exhibits those features instead of as being associated with other present code that does not hold/exhibit the feature. In at least some embodiments, the loss optimization to the machine learning model/neural network is applied alone to the minimal subsequence without other loss optimization. In other embodiments, the loss optimization to the machine learning model/neural network is applied first with the minimal subsequence and then with other additional training, e.g., with training data sets formed with data augmentation of the minimal subsequence and/or with code-complexity-ranked ordering of training samples for loss optimization.

The true class label 110 is obtained from an oracle which in various embodiments includes one or more of a human domain expert, an original dataset labeler (human or machine learning model), a line-based code-feature matcher, a static analyzer, an automated analyzer, a dynamic analyzer, and a fuzzer. The automated oracles are part of and/or accessed by the program 616. For a human oracle, the human oracle interacts with a user interface generated by the program 616 to provide the true class label for the minimal subsequence. In some embodiments, the oracle is an automated analyzer which applies some set of rules, e.g., heuristics, to check for certain features in code. The oracle in at least some embodiments is rule based and does not require machine learning or artificial intelligence.

The above-specific examples related to embodiments in which the machine learning model is being trained to perform bug or vulnerability detection. In another embodiment the signal-awareness techniques described herein are applied to a machine learning model that is being trained to perform a naming function for the input code. The input code is input into the machine learning model and in response the machine learning model predicts a name (e.g., a type of class) of the code. In one example, the machine learning model predicts a name of “binary search” for a first code sample that is input. The first code sample is reduced to find valid reduced portions that are resubmitted to the machine learning model to check for name prediction preservation. For reduced portions that also cause the machine learning model to make a prediction of “binary search”, these reduced portions are preserved and maintained for further reduction investigation until a minimal subsequence is found. If during the re-query to the machine learning model, the machine learning model changes the name prediction, e.g., predicts a naming function of sorting or list reversal, then the prediction was not preserved and that reduced code sample is not suitable for the further model-awareness training or for using as a root for further reduction investigation. For this embodiment, the oracle is in some sub-embodiments a trained analyzer. The trained analyzer is trained with rules to apply small sets of data to the analyzed code to determine if the analyzed code performs various functions such as search, sorting, or reversal. If the analyzed code successfully performs the task (search, sorting, reversal, etc.), the trained analyzer automatically provides the ground truth label associated with that task for this analyzed code/minimal sub-sequence.

In another embodiment, the signal-awareness techniques described herein are applied to a machine learning model that produces a prediction of a non-vulnerable input code sequence. The prediction preservation is performed by finding smaller valid sequences of the code which also cause the model being probed to give a non-vulnerable prediction. Other aspects of the vulnerability use case described above apply for this embodiment in reverse with respect to the model predictions of non-vulnerable code as opposed to vulnerable code.

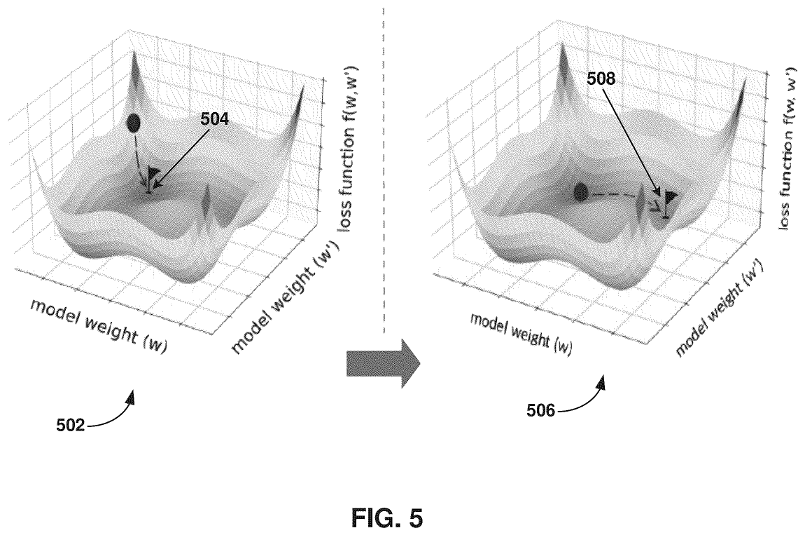

FIG. 5 illustrates aspects of finding an additional local minimum according to at least one embodiment using the above-described training for the machine learning model to be more signal aware. Machine learning models in some instances are trained to find a first minimum 504 (in the original feature ML space 502 shown in FIG. 5). By performing the training for signal awareness described herein, the machine learning model is trained to find a new local minimum 508 (in the optimized ML space 506 shown FIG. 5). The new local minimum 508 indicates a position where the optimized machine learning model maintains similar or improved performance compared to the model condition shown in space 502 but in which more task-relevant features are captured/recognized by the optimized machine learning model. In some instances, other local minima are also found via the training.

It may be appreciated that FIGS. 1-5 provide only illustrations of certain embodiments and do not imply any limitations with regard to how different embodiments may be implemented. Many modifications to the depicted embodiment(s), e.g., to the particular steps and/or order of the components of the depicted pipelines, may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as training program 616 for signal aware machine learning model. In addition to training program 616 for signal aware machine learning model, computing environment 600 includes, for example, computer 60i, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and training program 616 for signal aware machine learning model), peripheral device set 614 (including user interface (UI) device set 623, storage 624, and Internet of Things (IoT) sensor set 625), and network module 615. Remote server 604 includes renmote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores, Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in model signal awareness enhancement program 616 in persistent storage 613.

COMMUNICATION FABRIC 611 is the signal conduction path that allows the various components of computer 601 to communicate with each other, Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices, Operating system 622 may take several forms, such as various known proprietary operating systems or open source Portable Operating System Interface-type operating systems that employ a kernel. The code included in model signal awareness enhancement program 616 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing exceptionally large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices, Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603, In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601, For example, in a hypothetical case where computer 601 is designed and programmed to provide a recommendation based on historical data, then this historical data may be provided to computer 601 from remote database 630 of remote server 604.

PUBLIC CL-OUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

According to an aspect of the invention, a computer-implemented method includes training a machine learning model by inputting a code sequence. During the training, a minimal sub-sequence is extracted from the input code sequence. The minimal sub-sequence preserves a prediction of that the machine learning model made for the input code sequence. The minimal sub-sequence constitutes a valid program. A true class label for the minimal sub-sequence is obtained. The machine learning model is optimized with the true class label and by using the extracted minimal sub-sequence as a proxy for the input code sequence. In this manner, a machine learning model receives improved training to better recognize task-relevant features and to avoid relying on noise in the training data programming code. The machine learning model trained in this manner has enhanced trustworthiness, robustness, and reliability.

According to another aspect of the invention, for the computer-implemented method described initially the true class label is obtained from an oracle. In this manner, additional knowledge is harnessed to improve the machine learning model training so that the machine learning model is trained to perform inference more accurately.

According to another aspect of the invention, the above-described extracting of the minimal sub-sequence from the input code sequence includes iteratively reducing portions of the input code sequence to produce a smaller code sequence and inputting the smaller code sequence to the machine learning model until the minimal sub-sequence is obtained. The minimal sub-sequence is a smallest portion of the first sub-sequence that preserves the prediction by the machine learning model and that constitutes a valid program. In this manner, a machine learning model receives improved training to recognize task-relevant features more precisely and to better avoid relying on noise in the training data programming code. The machine learning model trained in this manner has extra-enhanced trustworthiness, robustness, and reliability.

According to another aspect of the invention, the above-described iterative reduction of the portions of the input code sequence includes removing tokens from a token set representing the input code sequence. In this manner, extraction is achievable with reduced extraction code so that less memory is required to host the extraction module.

According to another aspect of the invention, the above-described iterative reduction of the portions of the input code sequence includes inputting the smaller code sequence to the machine learning model to check for prediction preservation in response to a compiler, a code validator, or a code verifier indicating that the smaller code sequence constitutes a valid program. In this manner, reduction is investigated in an efficient and automated manner to carry out the reduction that will help result in better noise awareness by the machine learning model.

According to another aspect of the invention, the above-described optimizing of the machine learning model includes querying the machine learning model for prediction probability over the minimal sub-sequence, calculating a loss between the prediction probability and the true class label of the minimal sub-sequence, and adjusting one or more weights of the machine learning model to minimize the calculated loss. In this manner, one or more alternative minima in the model training loss landscape are obtained while maintaining performance and capturing more task-relevant features.

According to another aspect of the invention, the input code sequence is from a first programming language. The machine learning training method also includes repeating the steps with a further input code sequence from a second programming language that is different from the first programming language. In this manner, a machine learning model is trained which is more versatile by being able to analyze programming code from multiple computer programming languages. This technique helps train the machine learning model to be model language agnostic for multiple programming languages.

According to another aspect of the invention, the above-described prediction made by the machine learning model relates to a source code understanding task. The source code understanding task includes one or more of function naming, variable naming, code summarization, code recommendation, code completion, defect detection, vulnerability detection, and bug fixing. In this manner, machine learning models for a variety of code analysis tasks are enhanced to capture more task-relevant features.

According to another aspect of the invention, the trained machine learning model that is trained as described above is used to analyze newly input code for the source code understanding task. In this manner, technical advantages of the training enhancement are obtained so that newly input code receives more accurate and relevant analysis and recommendations.

According to another aspect of the invention, the machine learning model includes at least one member selected from a group consisting of a linear regression model, a logistic regression model, a support vector machine, a neural network, a decision tree, a gradient boosting machine, a K-means clustering model, and a generative adversarial network. In this manner, machine learning models that utilize loss minimization have parameters, e.g., nodes and/or weights, optimized and adjusted so that the machine learning model captures more task-relevant features.

According to an aspect of the invention, a computer system includes one or more processors, one or more computer-readable memories, and program instructions stored on at least one of the one or more computer-readable memories for execution by at least one of the one or more processors to cause the computer system to train a machine learning model by inputting a code sequence. During the training, the computer system extracts a minimal sub-sequence from the input code sequence. The minimal sub-sequence preserves a prediction that the machine learning model made for the input code sequence. The minimal sub-sequence constitutes a valid program. The computer system obtains a true class label for the minimal sub-sequence. The computer system optimizes the machine learning model with the true class label and by using the extracted minimal sub-sequence as a proxy for the input code sequence. In this manner, the computer system provides improved training to a machine learning model so that the model better recognizes task-relevant features, better avoids relying on noise in the training data programming code, and has enhanced trustworthiness, robustness, and reliability.

According to another aspect of the invention the above-described computer system obtains the true class label from an oracle. In this manner, the computer system harnesses additional knowledge to improve the machine learning model training so that the machine learning model is trained to perform inference more accurately.

According to another aspect of the invention, the above-described computer system extracts the minimal sub-sequence from the input code sequence by iteratively reducing portions of the input code sequence to produce a smaller code sequence and inputting the smaller code sequence to the machine learning model until the minimal sub-sequence is obtained. The minimal sub-sequence is a smallest portion of the first sub-sequence that preserves the prediction made by the machine learning model and that constitutes a valid program. In this manner, the computer system trains a machine learning model receives to recognize task-relevant features more precisely, to better avoid relying on noise in the training data programming code, and to have extra-enhanced trustworthiness.

According to another aspect of the invention, the above-described computer system iteratively reduces the portions of the input code sequence by removing tokens from a token set representing the input code sequence. In this manner, the computer system achieves extraction of the minimal subsequence with reduced extraction code so that less memory is required for the operation.

According to another aspect of the invention, the above-described computer system iteratively reduces the portions of the input code sequence by inputting the smaller code sequence to the machine learning model to check for prediction preservation in response to a compiler, a code validator, or a code verifier indicating that the smaller code sequence constitutes a valid program. In this manner, reduction is investigated in an efficient and automated manner to carry out the reduction that will help result in better noise awareness by the machine learning model.

According to another aspect of the invention, the above-described computer system optimizes the machine learning model by querying the machine learning model for prediction probability over the minimal sub-sequence, by calculating a loss between the prediction probability and the true class label of the minimal sub-sequence, and by adjusting one or more weights of the machine learning model to minimize the calculated loss. In this manner, the computer system obtains one or more alternative minima in model training loss landscape while maintaining performance and capturing more task-relevant features.

According to another aspect of the invention, the computer system receives the input code sequence in a first programming language. The computer system also repeats the steps with a further input code sequence from a second programming language that is different from the first programming language. In this manner, the computer system trains a machine learning model to be more versatile by being able to analyze programming code from multiple computer programming languages. This technique helps train the machine learning model to be model language agnostic for multiple programming languages.

According to another aspect of the invention, the above-described computer system trains a machine learning model that makes a prediction related to a source code understanding task. The source code understanding task includes one or more of function naming, variable naming, code summarization, code recommendation, code completion, defect detection, vulnerability detection, and bug fixing. In this manner, the computer system trains a machine learning model for a variety of code analysis tasks and that is enhanced to capture more task-relevant features.

According to another aspect of the invention, the computer system described above uses the trained machine learning model to analyze newly input code for the source code understanding task. In this manner, the computer system obtains new technical advantages for the trained machine learning model so that newly input code receives more accurate and relevant analysis and recommendations.

According to another aspect of the invention, the machine learning model trained by the computer system includes a neural network. In this manner, the computer system optimizes nodes and/or weights and/or layers of the machine learning model so that the machine learning model captures more task-relevant features.

According to an aspect of the invention, a computer program product includes a computer-readable storage medium having program instructions embodied therewith. The program instructions are executable by a computer to cause the computer to train a machine learning model by inputting a code sequence. During the training, the program instructions cause the computer to extract a minimal sub-sequence from the input code sequence. The minimal sub-sequence preserves a prediction that the machine learning model made for the input code sequence. The minimal sub-sequence constitutes a valid program. The program instructions cause the computer to obtain a true class label for the minimal sub-sequence. The program instructions cause the computer to optimize the machine learning model with the true class label and by using the extracted minimal sub-sequence as a proxy for the input code sequence. In this manner, the computer program product facilitates improved training to a machine learning model so that the model better recognizes task-relevant features, better avoids relying on noise in the training data programming code, and has enhanced trustworthiness.

According to another aspect of the invention the above-described computer program product causes the computer to obtain the true class label from an oracle. In this manner, the computer program product harnesses additional knowledge to improve the machine learning model training so that the machine learning model is trained to perform inference more accurately.

According to another aspect of the invention, the above-described computer program product causes the computer to extract the minimal sub-sequence from the input code sequence by iteratively reducing portions of the input code sequence to produce a smaller code sequence and inputting the smaller code sequence to the machine learning model until the minimal sub-sequence is obtained. The minimal sub-sequence is a smallest portion of the first sub-sequence that preserves the prediction made by the machine learning model and that constitutes a valid program. In this manner, the computer program product facilitates training a machine learning model to recognize task-relevant features more precisely, to better avoid relying on noise in the training data programming code, and to have extra-enhanced trustworthiness.

According to another aspect of the invention, the above-described computer program product causes the computer to iteratively reduce the portions of the input code sequence by removing tokens from a token set representing the input code sequence. In this manner, the computer program product causes the computer to achieve extraction with reduced extraction code so that less memory is required for the operation.

According to another aspect of the invention, the above-described computer program product causes the computer to iteratively reduce the portions of the input code sequence by inputting the smaller code sequence to the machine learning model to check for prediction preservation in response to a compiler, a code validator, or a code verifier indicating that the smaller code sequence constitutes a valid program. In this manner, reduction is investigated in an efficient and automated manner to carry out the reduction that will help result in better noise awareness by the machine learning model.

According to another aspect of the invention, the above-described computer program product causes the computer to optimize the machine learning model by querying the machine learning model for prediction probability over the minimal sub-sequence, by calculating a loss between the prediction probability and the true class label of the minimal sub-sequence, and by adjusting one or more weights of the machine learning model to minimize the calculated loss. In this manner, the computer program product facilitates obtaining one or more alternative minima in model training loss landscape while maintaining performance and capturing more task-relevant features.

According to another aspect of the invention, the computer program product causes the computer to receive the input code sequence in a first programming language. The computer program product also causes the computer to repeat the steps with a further input code sequence from a second programming language that is different from the first programming language. In this manner, the computer program product facilitates training of a noise-aware machine learning model that is also more versatile by being able to analyze programming code from multiple computer programming languages. This technique helps train the machine learning model to be model language agnostic for multiple programming languages.

According to another aspect of the invention, the above-described computer program product causes the computer to train a machine learning model that makes a prediction related to a source code understanding task. The source code understanding task includes one or more of function naming, variable naming, code summarization, code recommendation, code completion, defect detection, vulnerability detection, and bug fixing. In this manner, the computer program product facilitates training of a machine learning model for a variety of code analysis tasks and that is enhanced to capture more task-relevant features.

According to another aspect of the invention, the computer program product described above causes the computer to use the trained machine learning model to analyze newly input code for the source code understanding task. In this manner, the computer program product facilitates obtaining new technical advantages for the trained machine learning model so that newly input code receives more accurate and relevant analysis and recommendations.

According to another aspect of the invention, the computer program product causes the computer to train a machine learning model that includes a neural network. In this manner, the computer program product facilitates optimization of nodes and/or weights and/or layers of the machine learning model so that the machine learning model captures more task-relevant features.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
training a machine learning model by inputting a code sequence;
during the training, extracting a minimal sub-sequence from the input code sequence, the minimal sub-sequence preserving a prediction that the machine learning model made for the input code sequence, and the minimal sub-sequence constituting a valid program;
obtaining a true class label for the minimal sub-sequence; and
optimizing the machine learning model with the true class label and by using the extracted minimal sub-sequence as a proxy for the input code sequence.

2. The computer-implemented method of claim 1, wherein the true class label is obtained from an oracle.

3. The computer-implemented method of claim 1, wherein the extracting of the minimal sub-sequence from the input code sequence comprises iteratively reducing portions of the input code sequence to produce a smaller code sequence and inputting the smaller code sequence to the machine learning model until the minimal sub-sequence is obtained, the minimal sub-sequence being a smallest portion of the input code sequence that preserves the prediction by the machine learning model and that constitutes a valid program.

4. The computer-implemented method of claim 3, wherein the iteratively reducing the portions of the input code sequence comprises removing tokens from a token set representing the input code sequence.

5. The computer-implemented method of claim 3, wherein the smaller code sequence is input to the machine learning model to check for prediction preservation in response to a compiler, a code validator, or a code verifier indicating that the smaller code sequence constitutes a valid program.

6. The computer-implemented method of claim 1, wherein the optimizing of the machine learning model comprises:
querying the machine learning model for prediction probability over the minimal sub-sequence;
calculating a loss between the prediction probability and the true class label of the minimal sub-sequence; and
adjusting one or more weights of the machine learning model to minimize the calculated loss.

7. The computer-implemented method of claim 1, wherein the input code sequence is from a first programming language and the method further comprises:
repeating the steps with a further input code sequence from a second programming language that is different from the first programming language.

8. The computer-implemented method of claim 1, wherein the prediction relates to a source code understanding task selected from a group consisting of function naming, variable naming, code summarization, code recommendation, code completion, defect detection, vulnerability detection, and bug fixing.

9. The computer-implemented method of claim 8, further comprising implementing the trained machine learning model to analyze newly input code for the source code understanding task.

10. The computer-implemented method of claim 1, wherein the machine learning model comprises at least one member selected from a group consisting of a linear regression model, a logistic regression model, a support vector machine, a neural network, a decision tree, a gradient boosting machine, a K-means clustering model, and a generative adversarial network.

11. A computer system comprising:
one or more processors, one or more computer-readable memories, and program instructions stored on at least one of the one or more computer-readable memories for execution by at least one of the one or more processors to cause the computer system to:
train a machine learning model by inputting a code sequence;
during the training, extracting a minimal sub-sequence from the input code sequence, the minimal sub-sequence preserving a prediction that the machine learning model made for the input code sequence, and the minimal sub-sequence constituting a valid program;
obtain a true class label for the minimal sub-sequence; and
optimize the machine learning model with the true class label and by using the minimal sub-sequence as a proxy for the input code sequence.

12. The computer system of claim 11, wherein the true class label is obtained from an oracle.

13. The computer system of claim 11, wherein the extracting of the minimal sub-sequence from the input code sequence comprises iteratively reducing portions of the input code sequence to produce a smaller code sequence and inputting the smaller code sequence to the machine learning model until the minimal sub-sequence is obtained, the minimal sub-sequence being a smallest portion of the input code sequence that preserves the prediction by the machine learning model and that constitutes a valid program.

14. The computer system of claim 13, wherein the iteratively reducing the portions of the input code sequence comprises removing tokens from a token set representing the input code sequence.

15. The computer system of claim 13, wherein the smaller code sequence is input to the machine learning model to check for prediction preservation in response to a compiler, a code validator, or a code verifier indicating that the smaller code sequence constitutes a valid program.

16. The computer system of claim 11, wherein the optimizing of the machine learning model comprises:
querying the machine learning model for prediction probability over the minimal sub-sequence;
calculating a loss between the prediction probability and the true class label of the minimal sub-sequence; and
adjusting one or more weights of the machine learning model to minimize the calculated loss.

17. The computer system of claim 11, wherein the prediction relates to a source code understanding task selected from a group consisting of function naming, variable naming, code summarization, code recommendation, code completion, defect detection, vulnerability detection, and bug fixing.

18. The computer system of claim 11, wherein the machine learning model comprises a neural network.

19. A computer program product comprising a computer-readable storage medium having program instructions embodied therewith, the program instructions executable by a computer to cause the computer to:
train a machine learning model by inputting a code sequence;
during the training, extracting a minimal sub-sequence from the input code sequence, the minimal sub-sequence preserving a prediction that the machine learning model made for the input code sequence, and the minimal sub-sequence constituting a valid program;
obtain a true class label for the minimal sub-sequence;
optimize the machine learning model with the true class label and by using the extracted minimal sub-sequence as a proxy for the input code sequence.

20. The computer program product of claim 19, wherein the extracting of the minimal sub-sequence from the input code sequence comprises iteratively reducing portions of the input code sequence to produce a smaller code sequence and inputting the smaller code sequence to the machine learning model until the minimal sub-sequence is obtained, the minimal sub-sequence being a smallest portion of the input code sequence that preserves the prediction by the machine learning model and that constitutes a valid program.
